(19) United States
(12) Patent Application Publication
(10) Pub. No.: US 2016/0125366 A1
(43) Pub. Date: May 5, 2016

(54) Method and Apparatus for Interactive Vehicle Service Reception

(71) Applicant: Ford Global Technologies, LLC, Dearborn, MI (US)

(72) Inventors: Kenneth James McCaffrey, Canton, MI (US); David Alan Ziegler, South Lyon, MI (US)

(21) Appl. No.: 14/530,024

(22) Filed: Oct. 31, 2014

(51) Int. Cl. G06Q 10/00; G06Q 10/10; G07C 5/00

(52) U.S. Cl. CPC G06Q 10/20; G07C 5/008; G06Q 10/1095

(57) ABSTRACT

A system includes a processor configured to retrieve an appointment from a service appointment schedule. The processor is also configured to contact a vehicle associated with the retrieved appointment and determine if the vehicle is on-site at a service location. The processor is further configured to query a current vehicle location and vehicle destination if the vehicle is not on-site. Also, the processor is configured to determine if the vehicle is en-route to the service location based on the vehicle location and destination and update the appointment schedule with an expected arrival time if the vehicle is en-route. Once the vehicle is on-site, the processor can perform numerous interactions with the vehicle to provide a highly automated customer experience.

### TECHNICAL FIELD

The illustrative embodiments generally relate to a method and apparatus for interactive vehicle service reception.

### BACKGROUND

Vehicle computing systems have advanced significantly over the last decade. Drivers can now obtain on-demand music, navigation and emergency assistance through the use of telematics systems. Vehicles may be provided with connectivity to, or installation of, wireless communication devices (e.g., without limitation, phones, tablets, computers, routers, modems, etc.) that provide on-demand connectivity for a variety of user-services. Using these systems, numerous improvements to the driver experience have been suggested. Drivers are becoming accustomed to having their vehicles interface with, and integrate with, connected services in an ever increasingly connected environment.

Radio frequency identification has been used in cooperation with the computer system aboard a motor vehicle to track service and maintenance activities relating to the vehicle. Each component or part of the vehicle that may require maintenance is provided with a unique passive identification tag. The output data from the tag is read by a reader placed in proximity to the tag, and the data is transmitted to an on-board computer module where it is processed, and the service record is updated. A data stream converter may be used to process the information read by the reader into a format that is acceptable to the on-board computer. The data from the on-board computer is stored in a device external to the computer. Provisions are included for notification to the user, the auto dealer, or service other agency as needed.

Vehicle diagnostic data may be communicated to a vehicle service provider using sensor signals indicative of the status or condition of vehicle components. A diagnostics module in the vehicle generates diagnostic data based on the sensor signals and transfers the diagnostic data to a communications module of a hands-free phone system in the vehicle. The communications module wirelessly communicates the diagnostic data to a Bluetooth enabled cell phone in the vehicle. The cell phone communicates the diagnostic data to an Internet server. The provider accesses the diagnostic data from the Internet server using a computer connected to the Internet to determine if any of the vehicle components are in need of repair or maintenance. The provider notifies a user of the vehicle of any vehicle component that is in need of repair or maintenance.

### SUMMARY

In a first illustrative embodiment, a system includes a processor configured to retrieve an appointment from a service appointment schedule. The processor is also configured to contact a vehicle associated with the retrieved appointment and determine if the vehicle is on-site at a service location.

The processor is further configured to query a current vehicle location and vehicle destination if the vehicle is not on-site. Also, the processor is configured to determine if the vehicle is en-route to the maintenance location based on the vehicle location and destination and update the appointment schedule with an expected arrival time if the vehicle is en-route.

In a second illustrative embodiment, a system includes a processor configured to determine an available service timeslot. The processor is also configured to search a database of available vehicle connections for a vehicle in need of service. Further, the processor is configured to determine if needed servicing can be performed in the available timeslot and send a service recommendation to the vehicle if the needed servicing can be performed in the available timeslot.

In a third illustrative embodiment, a system includes a processor configured to receive diagnostic data from a wirelessly-connected vehicle. The processor is also configured to retrieve customer and vehicle system information relating to the vehicle. Further, the processor is configured to determine service recommendations based on at least one of the received diagnostic data, the retrieved customer data and the retrieved vehicle system data. The processor is additionally configured to retrieve data relating to part and cost options corresponding to the service recommendations and populate a display with a visual representation of the vehicle, identifying the service recommendations.

In a fourth illustrative embodiment, a system includes a processor configured to detect that a vehicle is in a designated service area. The processor is also configured to retrieve information identifying a customer associated with the vehicle. Further, the processor is configured to populate a welcome screen, provided in the service area, with customer welcome information. The processor is additionally configured to determine if an interactive customer terminal is available for use and reserve an available interactive customer terminal for the customer.

### BRIEF DESCRIPTION OF THE DRAWINGS

FIG. 1 shows an illustrative vehicle computing system;

FIG. 2 shows an illustrative process for connecting to a customer vehicle;

FIG. 3 shows an illustrative process for dynamic maintenance scheduling;

FIG. 4 shows an illustrative process for providing recommended maintenance information;

FIG. 5 shows an illustrative set of customer profiles;

FIG. 6 shows an illustrative vehicle profile; and

FIG. 7 shows an illustrative customer interaction process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

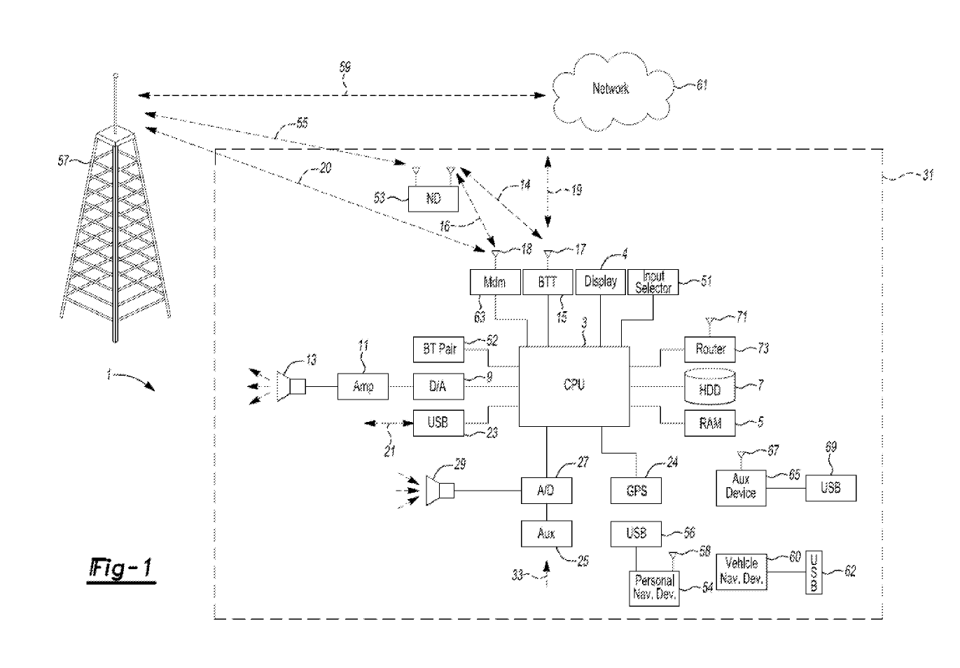

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments provide for an advanced customer experience with regards to a dealer or mechanic. Through use of the embodiments, many transactions that now require significant work and or understanding are made easily enabled, and the customer experience can be improved through improved ease of process and understanding.

For example, without limitation, customers currently arriving at a vehicle typically park out front of the dealer, or, if a mechanic bay is open, park in the bay. Then the customer has to fill out paperwork on the vehicle, while standing across a counter from a check-in person who then fills in information on a computer screen. While the computer screen typically isn't viewable by a customer, even if the screen were viewable it frequently contains information that appear largely as gibberish to the customer.

Following the check in, the customer often then travels to a room and waits until a mechanic or other service person can discuss suggested maintenance. Often, during this time, the customer has little to do, and the customer can easily grow impatient while waiting for something to happen. Through the use of the illustrative embodiments, many aspects of this entire experience can be improved.

For example, using one aspect of the illustrative embodiments, the customer's vehicle can be connected via wireless communication to the dealer maintenance system once a customer arrives at the dealership. This allows the system to query the vehicle for diagnostic codes, and notifies the dealer that the customer has arrived. Further, a bay can be cleared for an appointed time, customer profile information can be obtained, and any customer incentives can be suggested, all before the customer even pulls up to the bay.

Using another aspect of the illustrative embodiments, the queried diagnostic codes can be used to determine suggested maintenance. Additionally, any recall or other suggested maintenance can also be retrieved, and all this information can be formatted into a visually easy to understand display for customer utilization. Another display, in the bay, can show a customer name and present a welcome screen and directions as a customer pulls into the bay. This ensures that the customer knows they are in the correct location, and improves customer interaction by letting the customer know immediately that the dealership is aware of their presence.

Further, once the customer leaves the vehicle, most or all of the data needed has already been retrieved, so the customer can avoid irritating paperwork. The customer can proceed directly to an interactive screen, where the vehicle maintenance recommendations can be displayed in an interactive and easy to understand manner. A maintenance specialist can then sit with the customer, show options for each maintenance suggestion, including costs and variables, and can thus work with the customer to provide a much more user-friendly experience.

The customer experience can be made more favorable right from the time of vehicle purchase. The customer can utilize a dealer system, such as a tablet, for example, to select maintenance preferences, transportation needs and even beverage or food preferences for later visits. Using this information, stored in a dealer system (which can be either a part of or accessible by a dealer management system), future service reminders can be sent, and the system can instruct preparation of consumables and a loaner car, if needed, when the customer comes in for a service appointment.

The dealer management system can also manage an inventory and part and labor pricing. Using the illustrative embodiments in communication with the dealer management system, identification of available parts for service visits can be made in advance of the visit. Costs for the installation/repair needed during the visit can be projected, and the information can all be retrieved and prepared in advance of a customer arrival.

Further, the parts for a particular appointment can be ordered if they are not yet in inventory, and the parts can be laid out and provided to the mechanic in advance of the visit, saving time while the customer is present onsite. In at least one example, a “smart” cart can be used to deliver the parts to a technician. This cart could be pre-loaded with a number of parts for different orders, and could provide access to the relevant parts for a given order at the time of the appointment and/or when the cart is in proximity to the relevant vehicle or repair bay, for example. In at least one example, the cart could actually move autonomously to a given repair job, saving travel and wait time for the technician.

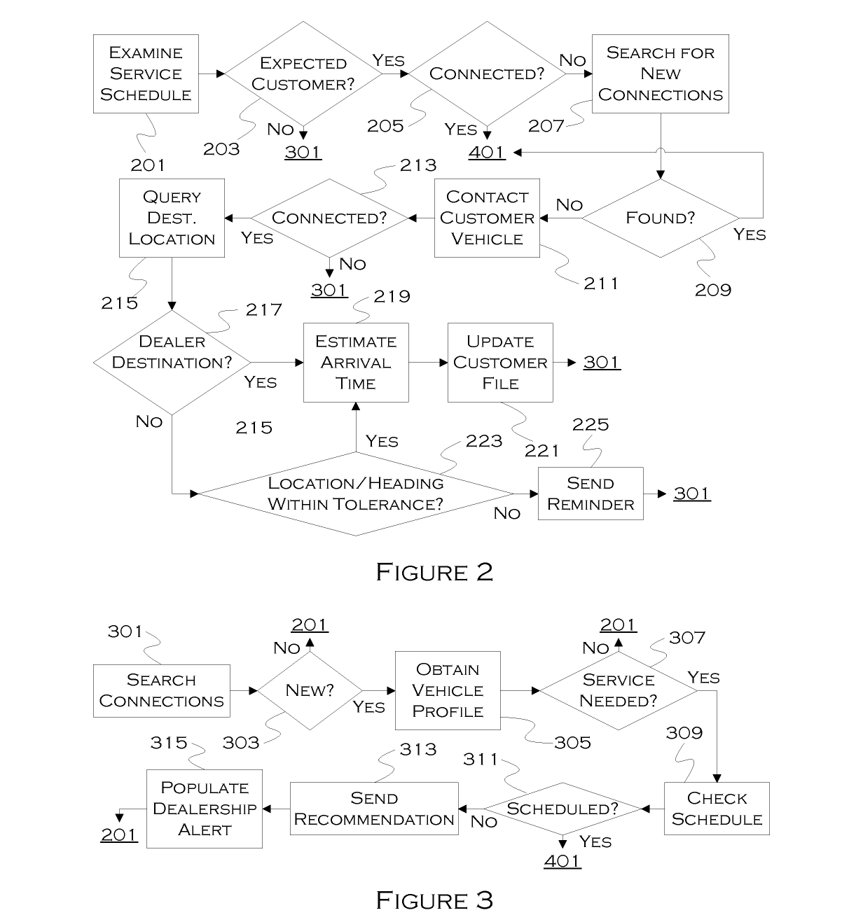

FIG. 2 shows an illustrative process for connecting to a customer vehicle. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative process, the dealership/mechanic seeks to communicate with a customer vehicle scheduled for maintenance, which may be either on the lot, en route, parked at some location or traveling to a different destination. A reminder can be sent if the vehicle is off-course or parked, because the customer may have forgotten the appointment. If the vehicle is present or en-route, appropriate steps can also be taken.

In this illustrative embodiment, the process examines a previously established service schedule 201. This schedule has, for example, all the appointments for a day, hour, week, etc. It identifies which vehicles/customers are expected and when, and is usable to retrieve scheduled upcoming appointments.

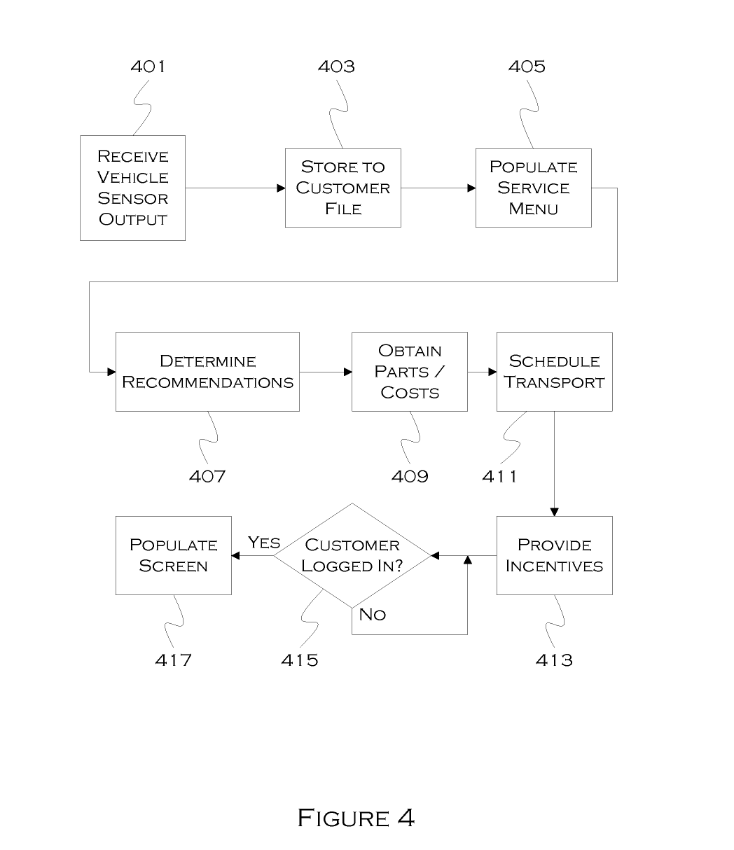

If a customer is expected 203, the process checks to see if the customer is already connected to the system 205. That is, if the customer is within proximity of whatever local wireless communication is used for retrieving vehicle data, the customer is considered “present.” In another example, long range wireless communication may be used to retrieve data in advance of arrival, and GPS coordinates can be used to determine whether or not the customer is actually present. If there are no customers expected, the process can proceed to FIG. 3, where another process attempts to fill empty maintenance slots. If the customer is already connected, the process can proceed to FIG. 4, wherein vehicle data can be obtained.

If the expected vehicle is not yet connected, the process may first search for on-site type connections 207, in case the vehicle has arrived and was simply not yet connected. If the vehicle is found 209, a local connection can be established and the process can begin to retrieve desired data. If the vehicle is not found, the vehicle is considered to be off-site and a possible reminder process can be engaged.

Through a long-range wireless connection, established, for example, without limitation, over cellular link with a vehicle, the process can contact the customer vehicle 211. If no connection is established, it is likely that the customer vehicle is parked and powered off. Accordingly, the system may determine that another vehicle can use the time slot, and so the process of FIG. 3 is engaged.

If the system is able to establish a connection with the customer vehicle 213, the system can check to see where the vehicle is currently located 215. Additionally, this query can include an indication of a set-destination in the vehicle navigation system 215. If the vehicle has the dealership as a current destination 217, the process knows that the customer is en-route and no reminder is provided, so as to avoid annoying the customer, in this example. Instead, based on a known customer location, and environmental variables (distance, traffic, weather, etc.), the system estimates a customer arrival time 219. The customer file can then be updated with the new projected arrival time 221, and if desired, the current un-used time slot can be attempted to be filled 301.

If the customer has a destination other than the dealer, or if no destination is set 217, the process checks to see if a current vehicle location/heading is within a tolerance that indicates that it is proximate to or likely heading to the dealership. For example, the customer may be within a predefined distance of the dealer. Or, in another example, the customer may be outside of the predefined distance, but headed in a direction that leads to the dealership. In one case, a route may be calculated from the current customer location to the dealer, and the process can monitor the vehicle to determine if the vehicle is on the route or within a predetermined tolerance of the route 223. If the customer appears to be headed to the dealership based on this location, the process can estimate an arrival time 219. Otherwise, the process may send a reminder to the customer 225, in case the customer forgot about the appointment, and then proceed to attempt to fill the empty slot if desired. The reminder can be sent via text, email, in-vehicle delivery system (e.g., display, audio) or in any other appropriate manner.

FIG. 3 shows an illustrative process for dynamic maintenance scheduling. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the dealership may have access to a database or records of available connections within, for example, a predetermined distance of the dealership 301. Additionally or alternatively, connections relating to vehicles sold by the dealership may be provided, regardless of distance. In other examples, other suitable lists of available connections may be provided. For example, if a maintenance slot is available, the process may search all available connections within three miles of the dealership.

If at least one connection is available 303, the process may connect to the vehicle and obtain a diagnostic profile of the vehicle 305. Or, if a diagnostic information is not available, records of previously identified diagnostic connection, recall notifications, etc. may be accessed for the vehicle (e.g., the vehicle has traveled 10,000 miles without an oil change).

If there is any indication that service is appropriate 307, the process may proceed with attempting to determine if maintenance would be appropriate. Further, it may only be appropriate to schedule maintenance that can be performed within an available time slot. Accordingly, the process may check the maintenance schedule to see how much time is available 309.

In conjunction with the schedule check, the process may determine if the vehicle is already scheduled for maintenance 311. If the vehicle is not currently scheduled, and if the maintenance can be performed in the available time slot, the process may send a recommendation to the vehicle that the vehicle be immediately brought in for available maintenance 313. This can include a request for customer confirmation, and if the customer confirms that they will bring the vehicle in, a dealership alert to appropriate personnel can be provided 315, so that the staff is ready when the vehicle arrives. Also, if the customer confirms that the maintenance suggestion is accepted, the process may fill in the available timeslot with an appointment for the vehicle.

FIG. 4 shows an illustrative process for providing recommended maintenance information. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process has already connected to an on-site vehicle that is scheduled for maintenance. In other illustrative examples, the vehicle may not yet be on-site, but the process may perform the illustrative steps, or similar steps, in any event.

The process receives sensor output from a variety of vehicle sensors 401, that is useful for determining what, if any, maintenance may be needed on the vehicle. This diagnostic information can be received in many forms, and may have been prepared in advance for the vehicle and/or stored in advance in the vehicle in some form suitable for transmission. In other examples, specific sensors may be queried based on, for example, a customer specification of a maintenance reason. The vehicle can provide vehicle or customer identification information when connected, or, in another example, the process may have specifically connected to a known vehicle.

Data received from the vehicle can be saved to a customer file 403 for updating a customer record and for present or future use. In the case of present use, the process can further retrieve customer information and use customer information and the retrieved vehicle data to populate a service menu 405. The service menu can, for example, contain at least the data that a customer would typically provide in writing or through verbal communication when arriving at the dealer.

Based on known customer information, known vehicle information, and retrieved vehicle diagnostic data, the process can determine one or more service recommendations for the vehicle 407. This can be based on systems identified as being in need of repair from diagnostic data, systems identified as being in need of repair/upkeep based on saved vehicle data, past customer preferences, and any other suitable factors.

The process can also obtain any part recommendations and/or costs affiliated with the recommended maintenance. If different part options are available, information on the options, including specifications and costs, can be obtained in advance, such that the customer does not have to wait while the information is retrieved. If the vehicle is going to be housed long-term, or if the customer has indicated that transportation to another location is needed, the transportation can be scheduled at this time so that it is ready as soon as the customer needs the information. This can include, but is not limited to, instructing preparation of a loan-vehicle, sending a schedule request to a customer transportation vehicle, or any other suitable steps to provide needed transportation.

Also, at this time, the process can determine if any incentives are appropriate. This can include incentives for which the customer is eligible, or incentives which the process determines might encourage a customer to purchase a recommended, but not needed, service. All of this information can be obtained once a connection to the vehicle is established and the customer is identified, although some of this information may be prepared at a prior advance time, saved with respect to a customer file, and merely retrieved when the customer arrives.

In this illustrative example, after exiting the vehicle, the customer is provided with a terminal on which information can be displayed and through which information can be interacted. The customer can be provided with a visual representation, based on the gathered information, of all recommended maintenance and upkeep with respect to the customer's vehicle. Once the customer has exited the vehicle and has logged into the appropriate terminal 415, the process can provide all desirable information to the customer via the terminal screen 417.

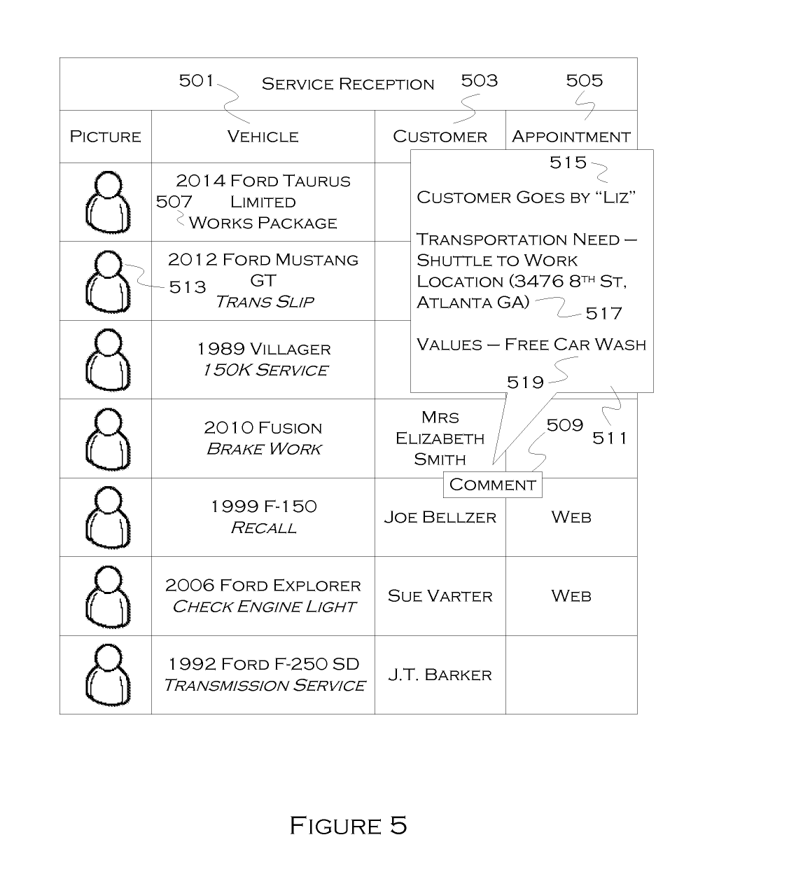

FIG. 5 shows an illustrative set of customer profiles. In this illustrative example, a plurality of customer profiles are provided for a service technician. This exemplary, non-limiting information shows an illustrative example of a display that might be shown to the technician. A picture of the customer may be shown 513, making visual identification of the customer easy, and making the customer feel like the dealer actually “knows” them. This can also make it easier to identify a customer who may be waiting with other customers.

Information relating to each customer's vehicle may also be shown 501, so that the technician can quickly correlate the customer to their vehicle. This information can identify, among other things, a make and model, and any customer-provided reason for the scheduled service trip 507.

A customer name may further be provided 503, which can provide identification of the customers. Comment information may also be included 509. This comment information can include customer specific needs, such as transportation 517, customer nicknames 515, customer incentives 519, and any other information usable to make the maintenance experience more pleasant, efficient, etc. A further column may identify how the customer made the appointment 505, and/or may also identify a specific appointment time and/or time block set aside for the appointment. Of course, other suitable information may also be included in this display as well.

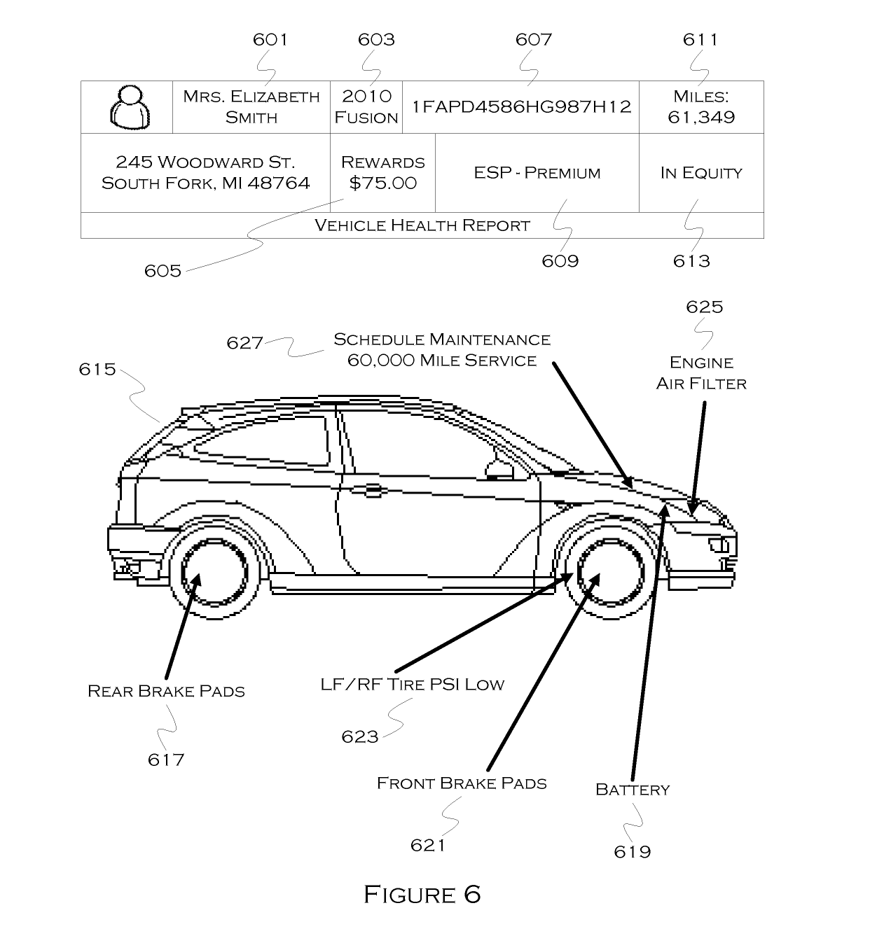

FIG. 6 shows an illustrative vehicle profile. This is a non-limiting example of what might be shown to a customer who is logged into a data-terminal. A customer name 601 helps ensure that the correct customer record is being viewed. Any misspellings of the customer name can also be identified here, and, if desired, could be changeable by the customer via the terminal (if interactive).

The customer's make and model are also provided 603, as well as a vehicle identification number (VIN) 607 and a current mileage 611. This can be provided (if desired) to ensure accuracy of information records, and to aid in completeness of the displayed customer profile. Again, if desired, at least some of this information can be correctable, although some information, such as the VIN, may require a dealer override to correct.

A customer address can be displayed as well. This can assist in ensuring that the dealership has the correct current address for the customer. Any eligible customer rewards may also be displayed 605. Another aspect of the illustrative display may include a customer service plan identification 609. And finally, in this example, an ownership state 613 may be provided.

In addition to the above information, in this example, the customer is shown a visual representation of a vehicle model 615 reflecting the identified vehicle belonging to the customer. In conjunction with the vehicle model, a variety of maintenance and service recommendations may be provided.

Although not shown, the recommendations can be color coded or otherwise include some indicia of severity. For example, in the illustration shown, the 60,000 mile service 627 might be marked “important” in some manner because the vehicle is 1,349 miles past the service mark. The engine air filter might 625 marked “low importance” because the filter is only in moderate need of replacement. Similarly, the rear brake pads 617 may be worn, but not in need of immediate replacement, so may be given a marking corresponding to recommended, but not necessarily needed, service. Appropriate designation can also be given to the tire pressure 623. Further unique identification could be given to specified reasons for the visit, in this case front brake squeaking 621 and battery issues 619, so the customer knows that the dealer is aware of specifically why the visit was made. Suitable formatting of the visual image can be adjusted as desired, with the general goal of providing a visual representation of one or more possible vehicle problems.

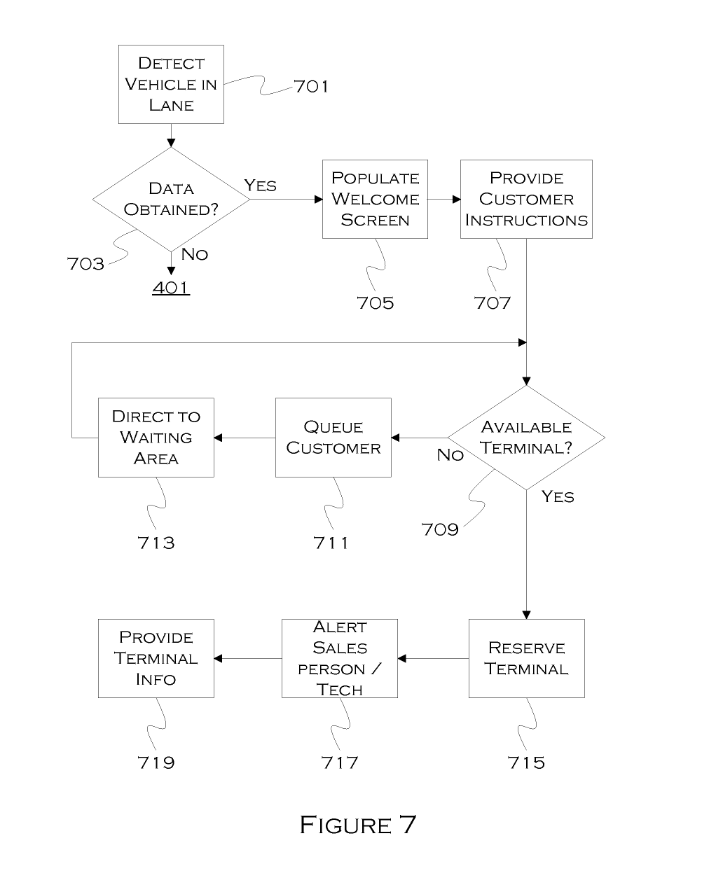

FIG. 7 shows an illustrative customer interaction process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a customer information delivery system is prepared for customer use. In a non-limiting environment, a display screen is provided and viewable by a customer seated in a vehicle or having just exited a vehicle. Once the vehicle is detected as being in the service lane 701, the process will obtain the needed data to perform the recommendations mentioned in FIG. 4, or in a similar process.

Once the data has been obtained 703, the process will populate a customer welcome screen (the display screen) with the appropriate information 705. Typically, although not necessarily, this will include at least a customer name. Any instructions for the customer may also be provided at this time 707. Instructions, for example, could be “please place vehicle in park and exit vehicle,” “please wait for no more than five minutes, assistance is on the way,” please exit the vehicle and proceed to the maintenance interaction terminals,” etc.

Also, in the example environment, one or more customer interaction terminals are provided for the customer to review maintenance requirements, suggestions, costs, etc. Accordingly, if there is at least one terminal not in use 709, the process may reserve that terminal for the identified customer 715, alert personnel to assist the customer in terminal use 717, and provide instructions to the customer on how to access the terminal 719. These instructions may be as simple as “proceed to terminal N,” or can be more complicated as needed. If appropriate, the instructions may be provided as part of a welcome screen (or displayed following a welcome display, etc.).

If there are no terminals available, the process may place the customer in a queue for terminal use 711, and request that the customer proceed to a waiting area (or other appropriate location) until such time as a terminal becomes available 713.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
retrieve an appointment from a service-appointment schedule;
contact a vehicle associated with the retrieved appointment;
determine if the vehicle is on-site at a service facility;
query a current vehicle location and vehicle destination if the vehicle is not on-site;
determine if the vehicle is en-route to the service facility based on the vehicle location and destination; and
update the appointment schedule with an expected arrival time.

2. The system of claim 1, wherein the processor is further configured to send a reminder to a vehicle owner if the vehicle is not en-route.

3. The system of claim 1, wherein the processor is further configured to retrieve vehicle diagnostic information if the vehicle is on-site.

4. The system of claim 1, wherein the processor is configured to determine that the vehicle is en-route based on a correspondence between the service facility and a currently input vehicle route destination retrieved as the vehicle destination.

5. The system of claim 1, wherein the processor is configured to determine that the vehicle is en-route based on the vehicle location being within a predefined distance of the service facility.

6. The system of claim 1, wherein the processor is configured to determine that the vehicle is en-route based on a correspondence between a vehicle heading and a direction from the vehicle to the service facility.

7. The system of claim 1, wherein the processor is configured to determine a route from the vehicle location to the service facility, and to determine that the vehicle is en-route based on repeated vehicle location requests resulting in locations that are within a predetermined tolerance of the determined route.

8. A system comprising:
a processor configured to:
determine an available service appointment timeslot;
search a database of available vehicle connections for a vehicle in need of service;
determine if needed service can be performed in the available timeslot; and
send a service recommendation to the vehicle if the needed servicing can be performed in the available timeslot.

9. The system of claim 8, wherein the processor is configured to determine that the vehicle is in need of service based on diagnostic information retrieved from the vehicle.

10. The system of claim 8, wherein the processor is configured to determine that the vehicle is in need of service based on a previously saved service reminder.

11. The system of claim 8, wherein the processor is further configured to receive confirmation from the vehicle that a customer has accepted the service recommendation.

12. The system of claim 11, wherein the processor is further configured to schedule an appointment in the available timeslot for the vehicle if the confirmation is received.

13. The system of claim 11, wherein the process is further configured to generate an alert for on-site personnel if a customer has accepted the service recommendation.

14. A system comprising:
a processor configured to:
receive diagnostic data from a wirelessly connected vehicle computer;
retrieve customer and vehicle system data;
determine vehicle service recommendations based on at least one of the diagnostic, customer, and vehicle system data;
communicate with a dealer-management system to retrieve part availability and cost data corresponding to the service recommendations; and
populate a display with the service recommendations, part availability, and cost data.

15. The system of claim 14, wherein the vehicle system data includes recall recommendations.

16. The system of claim 14, wherein the vehicle system data includes maintenance or repair recommendations previously saved with respect to the vehicle.

17. The system of claim 14, wherein the processor is configured to populate a display corresponding to a terminal into which a customer corresponding to the retrieved customer data has logged-in.

18. The system of claim 14, wherein the processor is configured to populate the display with a service-related incentive.

19. The system of claim 14, wherein the processor is configured to determine a transportation need of a customer and schedule transportation corresponding to the transportation need.

20. A system comprising:
a processor configured to:
detect that a vehicle is in a designated service area;
retrieve information identifying a customer associated with the vehicle based on vehicle detection;
populate a welcome screen, provided in the service area, with customer welcome information;
determine if an interactive customer terminal is available for use; and
reserve an available interactive customer terminal for the customer.

21. The system of claim 20, wherein the customer welcome information includes at least a customer name.

22. The system of claim 20, wherein the customer welcome information includes at least one customer instruction.

23. The system of claim 20, wherein the processor is further configured to alert personnel that a customer has arrived.

24. The system of claim 20, wherein the customer welcome information includes at least identification of the reserved interactive customer terminal.
